(19) United States
(12) Patent Application Publication
(10) Pub. No.: US 2011/0254421 A1
(43) Pub. Date: Oct. 20, 2011

(54) Cooling Structure For Bulb Shaped Solid State Lamp

(75) Inventor: Daniel L. Thomas, Las Vegas, NV (US)

(73) Assignee: NOVEL CONCEPTS, INC., Las Vegas, NV (US)

(21) Appl. No.: 12/760,936

(22) Filed: Apr. 15, 2010

(51) Int. Cl. H01J 61/52

(52) U.S. Cl. 313/46

(57) ABSTRACT

In one embodiment, an LED lamp has a generally bulb shape, such as a standard A19 shape. The section of the lamp between the LEDs' metal support platform and the screw-in base is a metal heat sink having the A19 form factor. The heat sink has metal fins that are asymmetrically arranged with respect to a center axis of the lamp such that, when the lamp's center axis is oriented vertically and the lamp is generating heat, the fins create an asymmetric air flow that moves through (across) a plane that is parallel to the center axis, wherein the air flow pattern is peripherally monoperiodic around the periphery of the lamp. Due to the asymmetric air flow pattern, the maximum air flow velocity is increased and asymmetric heat patterns result around the center axis, resulting in greater cooling of the heat sink.

### FIELD OF THE INVENTION

This invention relates to a structure for removing heat from a generally bulb-shaped solid state lamp, such as a high power light emitting diode (LED) lamp, and, in particular, to a fin design and cavity structure for the lamp.

### BACKGROUND

A huge market for LEDs is in replacement lamps for standard, screw-in incandescent light bulbs, commonly referred to as A19 bulbs. The letter “A” refers to the general shape of the bulb, including its base, and the number 19 refers to the maximum diameter of the bulb. Such a form factor is also specified in ANSI C78-20-2003. Therefore, it is desirable to provide an LED lamp that has the same screw-in base as a standard light bulb and approximately the same size diameter or less. Additional markets exist for replacing other types of standard incandescent bulbs with longer lasting and more energy efficient solid state lamps.

LEDs are only about 1 mm², so heat removal from high power LEDs is a difficult problem when the LED lamp has to adapt to a preexisting form factor. About 80%-90% of the LED power consumption is translated to heat. The temperature of an LED die should be kept relatively low (e.g., under 120° C.) to ensure the LED remains efficient and has a long life.

For a desirable LED lamp implementation, there are a few basic components: a standard (e.g., E26 or E27) base, an electronic driver (if needed) to convert the mains voltage into the required LED drive voltage, a heat sink, one or more LEDs to generate at least 600 lumens, and secondary optics to create a desired emission pattern, all contained within the A19 form factor or other standard form factor.

The current LED efficacy of 80-120˜lm/W translates to an LED lamp power of 7.5 W. Additionally, the driver internal to the lamp may add about 2-2.5 W to the system. For an Energy Star requirement or a TC-L70 35,000 hrs requirement, the die junction temperature should be maintained preferably below 120° C. High power LED lamps greater than about 7.5 W that can directly replace 40 W and 60 W incandescent light bulbs need innovative heat removal techniques to dissipate up to 10 W of heat without any active cooling.

It is known to provide metal fins extending from a bulb-shaped body to dissipate heat from an LED lamp. The fins are symmetrical around the body. The symmetrical fins on such known prior art solid state lamps are typically arranged vertically. A symmetrical pattern of fins causes the rising air flow around a vertically oriented lamp to be symmetrical and only in a plane parallel to the lamp's center axis. As a result, the temperature pattern is symmetrical around the lamp. When a bulb-shaped solid state lamp is used in a light fixture, such as a ceiling can, that orients the lamp so that its base is above the LEDs, there is generally some air flow obstruction above the lamp due to the design of the fixture. In such a case, the heated air builds up and air flow velocity around the lamp is reduced due to there being symmetrical air flow resistance around the lamp. As a result, the LEDs get much hotter, limiting the lumens output of a lamp that can be used with the fixture.

What is needed is a new approach to remove adequate heat from a high power LED lamp, or other solid state lamp, using only passive techniques, where the size of the lamp is constrained to, for example, an A19 form factor.

### SUMMARY

In one embodiment, a solid state lamp has a generally bulb shape, such as a standard A19 shape. Many other form factors are envisioned. The light source may be an array of LEDs. The section of the lamp between the LEDs and the screw-in base is a heat sink having the A19 form factor. The heat sink may be formed of molded aluminum or other thermally conductive material. Metal fins extend from a central shaft portion of the heat sink or other support structure in the heat sink. The fins are asymmetrically arranged with respect to the support such that, when the lamp's center axis is oriented vertically and the lamp is generating heat, the fins create an asymmetric air flow that moves through (across) a plane that is parallel to the center axis, wherein the air flow pattern is peripherally monoperiodic around the periphery of the lamp. The peripherally monoperiodic flow pattern means that there is no pattern of air flow that repeats around the center axis of the lamp. The lamp may have a generally circular shape around its center axis (like a bulb), or the lamp may have a non-circular shape.

In one embodiment, the fins are angled with respect to the center axis between an LED support platform and the lamp base. In one embodiment, if the heat sink is bisected vertically, the fin patterns on the two halves would be mirror images of each other (the fin angles are opposite on opposite sides of the lamp). Therefore, when looking down at the lamp along the center axis, the angled fins on both sides of the lamp are generally pointing toward the same side of the lamp. This results in an asymmetrical air flow pattern around the lamp's periphery. In contrast, if the fins were symmetrical around the heat sink (all have same angle around the periphery), the air flow would be symmetrical around the heat sink.

Many other asymmetrical arrangements of the fins are possible to create an asymmetrical air flow pattern, including vertical and angled arrangements of fins.

Due to the asymmetric air flow pattern around the center axis of the lamp, there are different air pressures and temperatures around the periphery of the lamp, so there are asymmetrical air flow resistances around the lamp. As a result of the asymmetric air flow resistances, the maximum air flow velocity at locations around the periphery increases compared to the maximum air flow velocities around lamp heat sinks with symmetrical vertical fins. The increased air flow velocity results in more volume of ambient air per unit time removing heat from the heat sink. Hence, there is greater overall cooling of the LEDs (or other solid state light source) than had the fins been arranged symmetrically.

The asymmetrical air flow and temperature pattern is particularly beneficial when the lamp is mounted “upside down” such as in a ceiling can which restricts upward air movement. The asymmetric air flow and asymmetric air temperature pattern tends to stir the air inside the ceiling can for increased cooling of the heat sink.

Computer simulations have proven that the maximum air flow velocity using the asymmetrical fin design is greater than the maximum air flow velocity using a symmetrical fin design, resulting in increased cooling. Computer simulations have also proven that the heat sink and LED temperatures using the asymmetrical fin design are lower than the temperatures using a symmetrical fin design.

Additionally, conventional vertical fins that symmetrically taper toward a base have a smaller and smaller air flow channel between the fins as the fins approach the base. This restricts the air flow between the fins. Various designs of fins are described herein, such as angled fins with a substantially constant gap between the fins, that result in substantially no air flow restrictions along the length of the lamp, causing greater cooling of the heat sink.

In one embodiment, there is an open area of the heat sink around the center axis of the lamp between the fins. An air vent is formed through the metal support platform that supports the LEDs to allow air to enter the area of the heat sink where the fins are located. This is particularly beneficial when the lamp is mounted in a cylindrical ceiling can and there is only a small air gap between the sides of the lamp and the ceiling can wall.

In one embodiment, the fins comprise a set of asymmetrically arranged angled fins and one or more vertical fins, where the vertical fins extend from a bottom surface of the LED support platform and intersect a plurality of the angled fins. The vertical fins conduct heat from the support to the plurality of the angled fins. The vertical fins also extend from the central shaft to conduct heat from the central shaft to the plurality of angled fins.

In one embodiment, the periphery of the bottom surface of the LED support platform is rounded to provide a reduction in air flow resistance as heated air flows from the heat sink and around a periphery of the lamp.

A novel cavity of the heat sink is also described. In some applications, it is desirable for the heat sink to have a central metal shaft to house a driver and wires and to conduct the LED heat along the length of the shaft so it can be better cooled by the fins. The hollow space for the driver and the wires that connect the driver to the LED module is a relatively poor conductor of heat. In one embodiment, the driver is located at the bottom of the heat sink near the base, so the base can conduct heat from the driver to the socket, and the driver is a maximum distance from the LEDs to limit heating of the LEDs by the driver. Additionally, since the LED module (comprising a metal circuit board populated with LEDs) typically has a power supply wire connection on only one edge of the module, the hole through the heat sink's shaft for the wire can be asymmetrical. The side of the shaft with the hole will have the highest thermal resistance, so the hole is positioned to be on the side of the heat sink where the cool ambient air enters the fin channels.

### BRIEF DESCRIPTION OF THE DRAWINGS

FIG. 1 is left side perspective view of the solid state lamp in accordance with one embodiment of the invention.

FIG. 2 is right side perspective view of the solid state lamp of FIG. 1.

FIG. 3 is a bottom up view of the solid state lamp of FIG. 1.

FIG. 4 is a top down view of the solid state lamp of FIG. 1.

FIG. 5 is a left side view of the solid state lamp, relative to the orientation of FIG. 2.

FIG. 6 is a front view of the solid state lamp, which is looking at the right side of the lamp of FIG. 5.

FIG. 7 is a right side view of the solid state lamp, relative to the orientation of FIG. 2.

FIG. 8 is a rear view of the solid state lamp, which is looking at the left side of the lamp of FIG. 5.

FIG. 9 is a view of the lamp mounted upside down in a ceiling can fixture and showing computer simulated asymmetrical equi-temperature lines around the lamp.

FIG. 10 is a top down view of the solid state lamp of FIG. 1 with the translucent cover removed, showing the LEDs on a metal circuit board, where the board is thermally coupled to a metal support of the heat sink, and showing, in dashed outline, the outer boundary of the central shaft.

FIG. 11 is a top down view of the central shaft, showing the asymmetrical opening for the wires between the LED circuit board and the driver.

FIG. 12 is a cross-sectional view of the metal support for the LED circuit board and the central shaft, where the shaft has an opening for the wires and a cavity for the driver.

FIG. 13A is a side view of the solid state lamp with a center shaft that does not fully extend between the base and metal support, allowing air to flow through the heat sink.

FIG. 13B is a top down view of the lamp of FIG. 13A with its translucent cover removed, illustrating a circular air vent through the lamp's LED support platform leading to the fin area of the lamp.

FIG. 14 is a perspective view of another embodiment illustrating a rounded bottom edge of the metal support for reducing air resistance as a rising air flow passes around the outer periphery of the lamp.

FIGS. 15, 16, 17, and 18 illustrate examples of other asymmetrical fin designs that create an asymmetrical air flow pattern around the center axis of the lamp.

Elements that are the same or similar in the various figures are identified with the same numeral.

### DETAILED DESCRIPTION

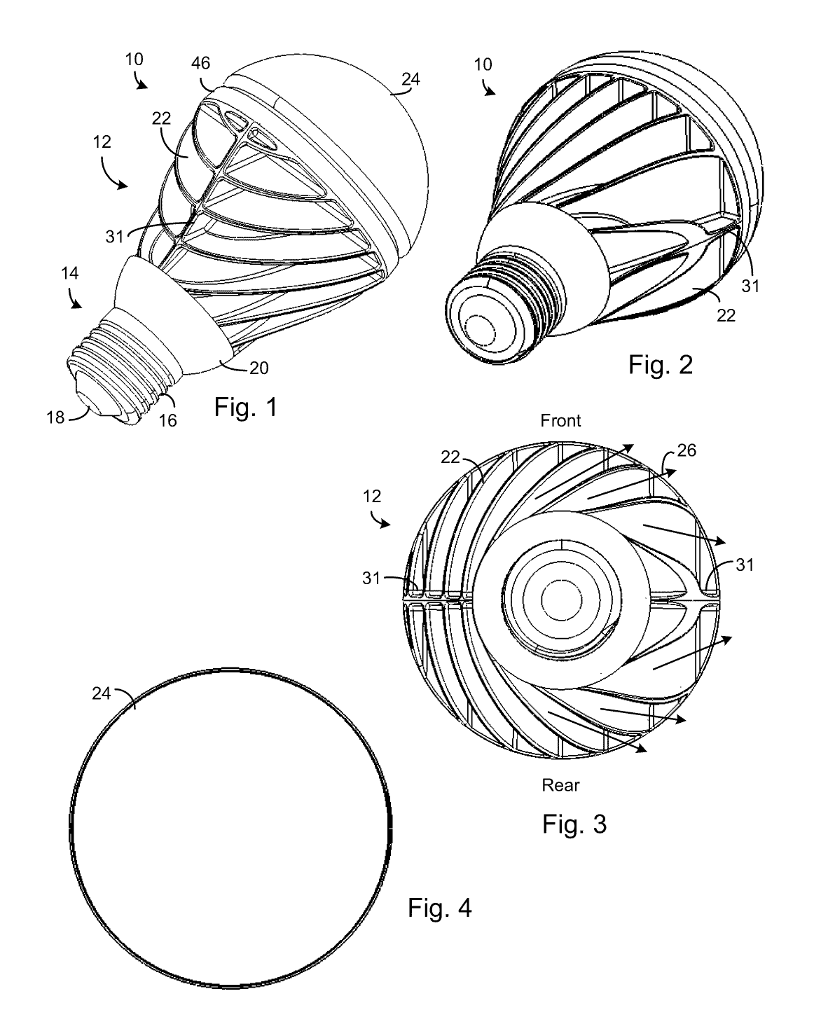

FIG. 1 is a left side perspective view (relative to FIG. 3) of one embodiment of a solid state lamp 10 having an A19 form factor to be used as a direct replacement of conventional light bulbs. The lamp 10 can have other form factors and other fin arrangements. In one embodiment, the heat sink 12 portion of the lamp 10 is molded aluminum. Aluminum has a thermal conductivity (k) of about 200 W/mK. Other thermally conductive materials can be used, such as copper (k=400 W/mK) or composite materials.

FIG. 1 shows a standard screw-in base 14 for the lamp 10. The base 14 is electrically insulated from the heat sink 12. The threaded portion 16 of the base 14 contacts a ground terminal of a socket connected to a mains voltage supply. The light fixture socket provides some heat sinking. The bottom terminal 18 of the base 14 contacts the “hot” terminal of the socket. A top portion 20 of the base 14 is thermally coupled to the heat sink 12. The coupling may be by a thermally conductive adhesive, a friction or screw-in fit, a bond, or other coupling.

The heat sink 12 has angled fins 22 extending from a central shaft of the heat sink 12.

The lamp 10 has a translucent cover 24 to diffuse the light from the LEDs mounted on the heat sink 12. In one embodiment, there are gaps between the cover 24 and the heat sink 12 to allow heated air to escape.

FIG. 2 is a right side perspective view of the lamp 10; FIG. 3 is a bottom up view of the lamp 10 with the translucent cover 24 removed; and FIG. 4 is a top down view of the lamp 10 showing the translucent cover 24.

As seen in the view of FIG. 3, the angled fin arrangement is a mirror image on the front and rear sides. The heat sink 12 may be molded as a single piece or as two pieces bonded together by any suitable metal-metal bond.

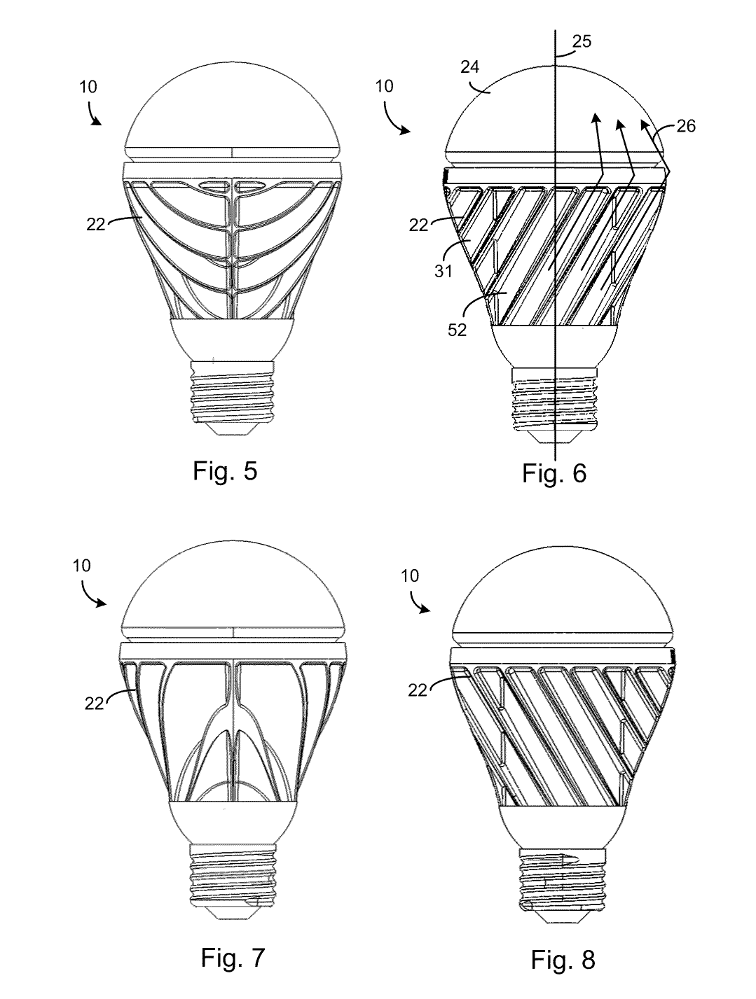

FIG. 5 is a left side view of the lamp 10, relative to FIG. 3, showing how all fins 22 are angled upward from the direction of left to right. FIG. 6 is a front view of the lamp 10, which is the right side of FIG. 5. FIG. 7 is a right side view of the lamp 10, relative to FIG. 3. FIG. 8 is a rear view of the lamp 10, which is the left side of FIG. 5.

In the example, the fins 22 extend a maximum of about 2-2.5 cm from a central shaft of the heat sink 12. The maximum width of the fins 22 depends on the width of the central shaft. A central shaft is not necessary for the invention.

The asymmetrical arrangement of the fins 22 causes an asymmetrical air flow to occur. If it is assumed the lamp 10 is oriented vertically in a fixture so that its base 14 is at the lowest point, the air heated between the fins 22 will flow upward in the angled direction of the fins 22, relative to the lamp's center line 25, as shown by the air flow lines 26 in FIGS. 3 and 6. In other words, the fins create an air flow that moves through (across) a plane that is parallel to the center axis 25, wherein the air flow pattern is peripherally monoperiodic around the periphery of the support. Once the air exits the fins 22, the rising air will flow along the hemispherical cover 24 of the lamp 12 and continue rising up since a low pressure is created above the lamp 10. Since the air flow between all fins 22, on all sides of lamp 10, is directed to the right side of the lamp 10 (FIG. 6), there is an asymmetric air flow and an asymmetric heat transfer into the ambient air.

The velocity of the rising air is related to the temperature of the air, air flow restrictions, and other factors. The gaps between the fins 22 are generally constant along the length of the lamp, so there is reduced air flow resistance between the fins 22, compared to prior art vertical fins having gaps that taper toward the narrow base. Further, since the air flows are all directed toward the same side, there is a reduction of opposing air flow forces around the periphery of the lamp compared to symmetrical air flows around prior art lamps. For at least these reasons, the heated air has a maximum velocity that is greater than the maximum velocity of air moving through prior art symmetrical vertical fins.

The increased air flow velocity results in more volume of ambient air per unit time removing heat from the heat sink 12. Hence, there is greater overall cooling of the LEDs (or other solid state light source) than had the fins been arranged symmetrically and vertically.

In a computer simulation, the maximum air flow velocity along a lamp with symmetrical and vertical fins, where the lamp was positioned vertically with its base at the lowest point, was 0.23 meters/second (m/s), while the maximum air flow velocity along the lamp 10 was 0.30 m/s.

In a computer simulation, for the lamp with symmetrical and vertical fins, where the lamp was positioned vertically with its base at the lowest point, the maximum heat sink temperature rise was 63.8° C., and the average LED junction temperature rise was 66.8° C. For the lamp 10, the maximum heat sink temperature rise was only 49.9° C., and the average LED junction temperature rise was only 53.6° C.

In a computer simulation, for the lamp with symmetrical and vertical fins, where the lamp was positioned vertically in a conventional four inch ceiling can with its base at the highest point, the maximum heat sink temperature rise was 78.4° C., and the average LED junction temperature rise was 81.9° C. For the lamp 10, the maximum heat sink temperature rise was only 69.9° C., and the average LED junction temperature rise was only 72.8° C.

The lamp 10 also has two vertical fins 31 (FIGS. 1-3) that are directly connected to the bottom surface of the support 46. These vertical fins 31 conduct heat vertically from the support 46 to the angled fins 22. The vertical fins 31 also help mechanically support those angled fins 22 that do not extend completely between the base 14 and the support 46. The vertical fins 31 are also directly connected to the central shaft 52 (FIG. 12), so the vertical fins 31 also help couple heat from the central shaft 52 to the angled fins 22.

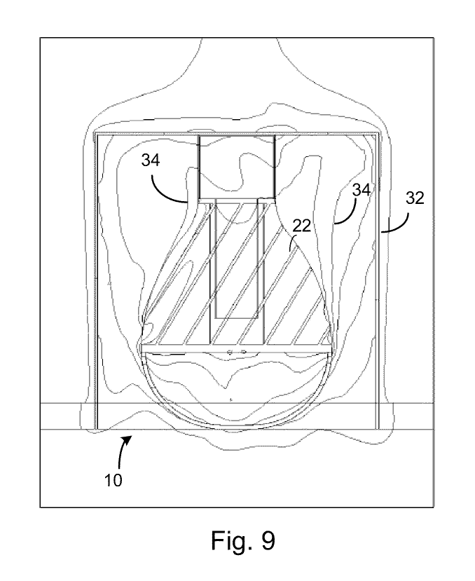

Due to the radially asymmetrical pattern of air flow (i.e., peripherally monoperiodic air flow pattern), there is an asymmetrical temperature pattern around the heat sink 12, as described with respect to FIG. 9. FIG. 9 is a simplified view of the lamp 10 mounted upside down in a four inch ceiling can 32, typically used for lighting a room, showing equi-temperature boundaries for various temperatures determined by computer simulation. One equi-temperature boundary 34, such as an air temperature of 360 K, around the lamp 10 will be discussed. In such a fixture, the cool air entrance into the ceiling can 32 and the heated air exit from the ceiling can 32 overlap to restrict air flow. The asymmetrical equi-temperature boundary 34 shows that there is more air flow along the right side (relative to FIG. 9) of the lamp 10 than along the left side, due to the asymmetrical fin arrangement. This asymmetric heating of the ambient air creates greater air turbulence in the fixture, reducing the countercurrent air flow forces, resulting in more total heat being removed from the lamp 10 by the air flow.

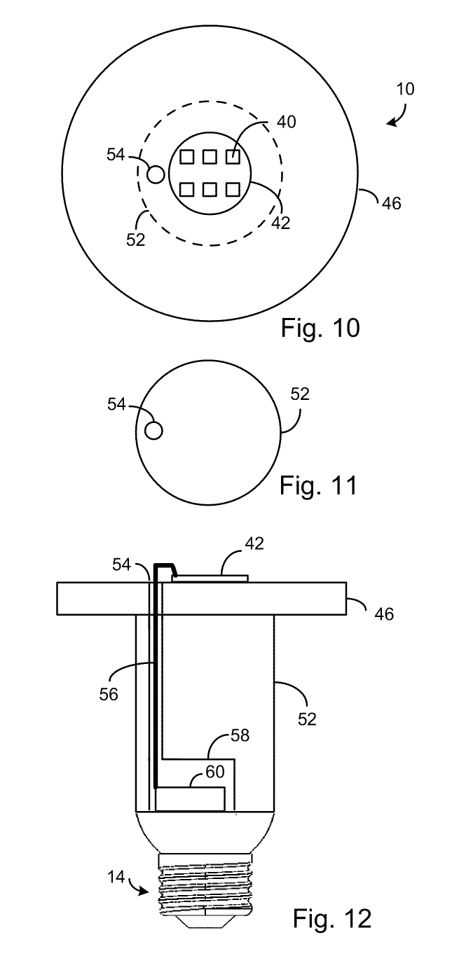

FIG. 10 is a top down view of the lamp 10 of FIG. 1 with the translucent cover 24 removed. Six high-power LED dies 40 are shown, but there may be more or fewer LEDs connected in series and/or parallel. Each LED die 40 is about 1 mm². Each LED die 40 is mounted on a metal core printed circuit board 42, which may be rectangular or circular. The printed circuit board 42 has a bottom surface thermally mounted on a metal support 46 forming part of the molded aluminum heat sink 12. The ends of most fins 22 are connected to the bottom surface of the metal support 46. In one embodiment, the board 42 is thermally coupled to a wide-diameter vapor chamber having a bottom surface thermally coupled to the metal support 46. Vapor chambers are better at spreading heat than a metal plate. Heat generated by the LED dies 40 flows through the board 42 and into the metal support 46. The metal support 46 is relatively thick so spreads the heat laterally (horizontally) as well as vertically. The edge of the metal support 46 is shown in FIGS. 1 and 12. A rising air flow through the fins 22 under the metal support 46 directly contacts the metal support 46 to remove heat.

In another embodiment, part of the metal support 46 is formed of a separate copper insert mounted within an indentation in the aluminum portion of the metal support 46. Since copper has a thermal conductivity much higher than that of aluminum, there is less thermal resistance in the resulting heat sink.

A central shaft 52 (FIG. 12) of the lamp 10 supports the fins 22 and extends between the screw-in base 14 and the metal support 46. The location of the shaft 52 is shown in dashed outline in FIG. 10. Heat from the metal support 46 is conducted to the top ends of the fins 22 and is conducted to the edges of the fins 22 via the central shaft 52. It is desirable that the central shaft 52 have a high thermal conductivity to conduct heat vertically. A solid metal shaft would be the best conductor, but room has to be made for the wiring and the driver. The width of the shaft 52 is a tradeoff between wider fins 22 (narrower shaft) and more vertical heat conduction (wider shaft). Ideally, the shaft 52 should be as wide as the circuit board 42 to couple heat from the circuit board 42 downward along the fins 22.

FIG. 11 is a top view of the shaft 52 with an opening 54 for the wiring to the printed circuit board 42.

FIG. 12 is a cross-sectional view bisecting the lamp 10 of FIG. 6 in the plane of the drawing but not showing the fins. The shaft 52 is solid except for the opening 54 for the wires 56 and a cavity 58 for the driver 60. The driver 60 may be much larger than that shown, requiring a larger cavity 58. The driver 60 converts the AC mains voltage to the current needed to drive the LED dies 40. The LED dies 40 may output 600-1000 lumens, for example. In one embodiment, the LED dies 40 output blue light and have a phosphor coating that adds red and green light components to produce a white light.

The driver 60 comprises components mounted on a metal core printed circuit board that is, in turn, mounted on a metal platform forming part of the molded aluminum heat sink 12. Much of the heat from the driver 60 is coupled to the socket via the screw-in base 14.

The heat coupled along the shaft 52 is coupled to the fins 22. The fins 22 have a larger surface area near the top (where the heat is greatest) due to the widening of the lamp 10 at the top.

The shaft 52 is asymmetrical, where the thermal resistance along the shaft 52 is less along the right side than along the left side due to the opening 54 for the wiring 56. The LED circuit board 42 is arranged so that its power connectors are near the edge of the board 42 nearest the opening 54.

If the lamp 10 is optimized for being vertically oriented in a fixture such that air flow will be from left to right across the heat sink, the opening 54 should be on the left side of the lamp 10 since cooler air enters the left side. The optimal position of the opening 54 will therefore depend on whether the lamp 10 is optimized for being vertically oriented with its base down or up.

In one embodiment, there are 18 fins 16 that extend from the cylindrical center shaft 52 to the outer periphery of the bulb form factor (e.g., A19 form factor). The angle of the fins is between 20-40 degrees relative to the centerline, and preferably about 30 degrees.

In another embodiment, the driver is deleted, and there are a sufficient number of LEDs connected in series so the LED currents are within an acceptable range.

In one embodiment, there is no central shaft that extends between the base and the LED support, or the central shaft is discontinuous. In such a case, the base is mechanically secured to the LED support by the fins. This allows the air to flow through the middle of the lamp, resulting in less air restriction and increased air velocity for better cooling.

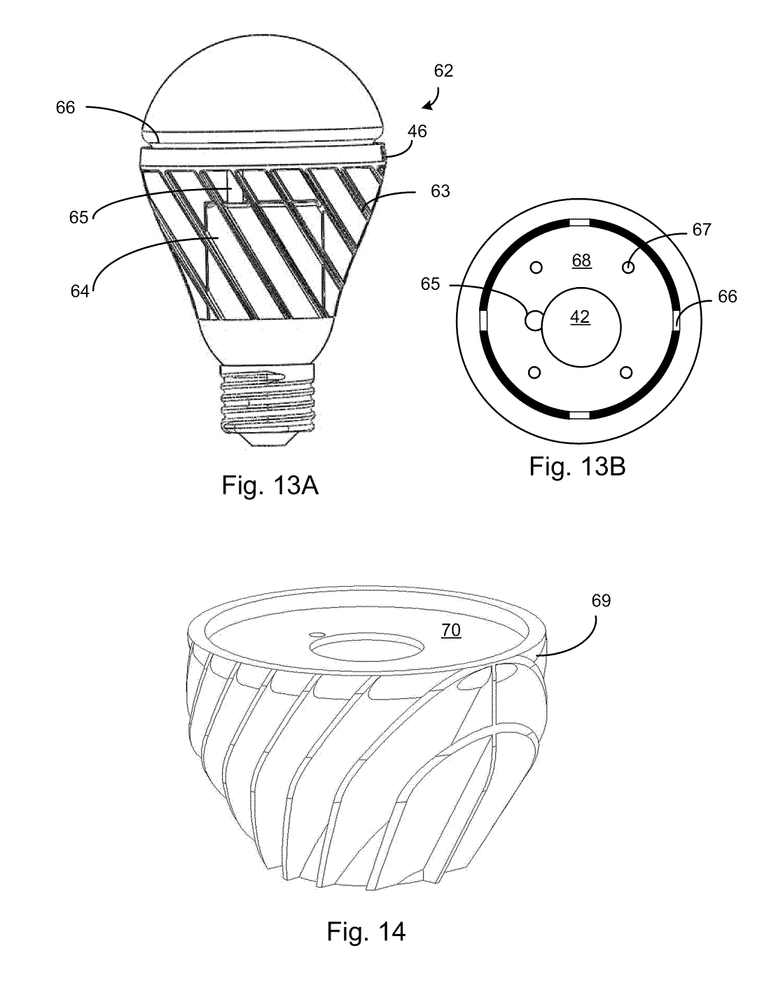

FIG. 13A illustrates a lamp 62 with asymmetrical fins 63 similar to the lamp 10, but where the central shaft is discontinuous. A bottom portion 64 of the shaft has a cavity that houses the driver, and the wires between the driver and the LED circuit board run through a thin metal conduit 65. Since the area above the portion 64 is open, air is allowed to flow through the center of the heat sink for additional cooling. The fins across the open portion of the heat sink (i.e., anywhere where the central shaft is not located) may extend completely across the lamp, so the fins have greater surface area for better cooling. Further, the fins across the open portion have a long edge in direct contact with the bottom surface of the LED's metal support 46 for improved cooling of the LEDs.

Additionally, there are air vents 66 through the heat sink's LED support that lead to the open area above the portion 64. FIG. 13B is a top down view of the lamp 62 with its cover removed. In the event that the lamp 62 is mounted upside down in a cylindrical ceiling can, where there is only a small gap between the sides of the lamp 62 and the wall of the ceiling can, the cool air flow can enter the heat sink area through any of the air vents 66 and 67 in the metal support 68.

FIG. 14 is a perspective view of another embodiment of a lamp heat sink portion illustrating a rounded bottom edge 69 of the metal support 70 for reducing air resistance as a rising air flow passes around the outer periphery of the lamp. The remaining lamp features may be those previously described.

Although a standard light bulb form factor has been used in the examples, other incandescent and fluorescent bulb form factors may also be used for the solid state lamp. The base may be a plug-in base or have other types of connectors. A list of standard bulb and socket form factors can be found at http://www.donsbulbs.com/cgi-bin/r/t.pl/socket.base.html, copyright 2009, incorporated herein by reference.

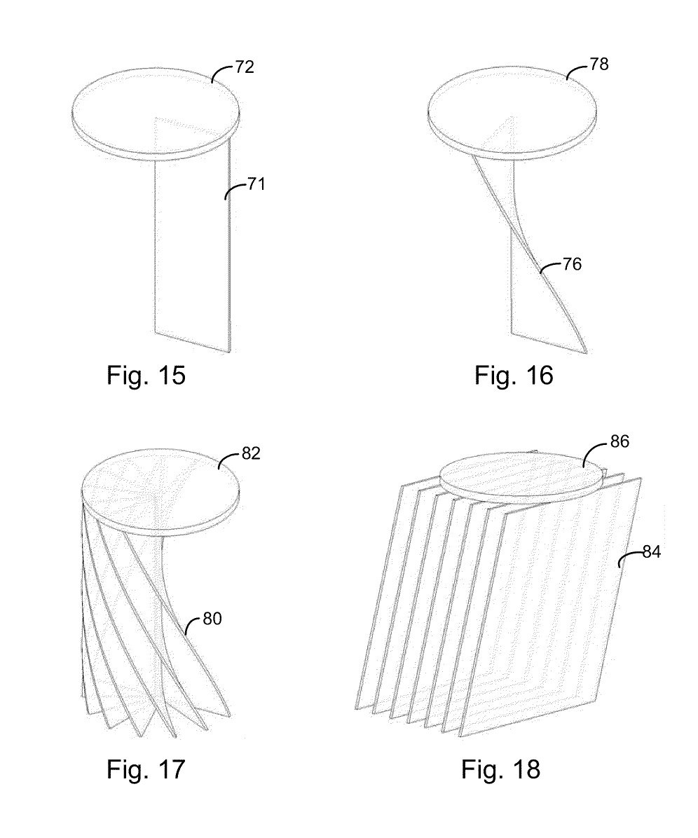

The asymmetrical arrangement of the fins to generate an asymmetrical air flow pattern may take many forms. FIGS. 15-18 illustrate some examples of other asymmetrical fin patterns and heat sink form factors. The resulting air flow patterns are peripherally monoperiodic air flow patterns, meaning that there is no pattern of air flow that repeats around the center axis of the lamp. The air flows created in the area of the heat sinks flow through (across) a plane parallel to the center axis, rather travelling in a plane parallel to the center axis as would be the case for symmetrical fins. All the examples can be adapted to include a base having a standard connector and adapted to match a standard form factor for a lamp.

FIG. 15 illustrates a single vertical fin 71, asymmetrically located with respect to the metal support 72, for generating an asymmetrical air flow for cooling a solid state light source mounted on the metal support 72.

FIG. 16 illustrates a single spiral fin 76, asymmetrically located with respect to the metal support 78, for generating an asymmetrical air flow for cooling a solid state light source mounted on the metal support 78.

FIG. 17 illustrates a set of spiral fins 80, asymmetrically located with respect to the metal support 82, for generating an asymmetrical air flow for cooling a solid state light source mounted on the metal support 82.

FIG. 18 illustrates a set of flat and angled fins 84, asymmetrically located with respect to the metal support 86, for generating an asymmetrical air flow for cooling a solid state light source mounted on the metal support 86.

Having described the invention in detail, those skilled in the art will appreciate that given the present disclosure, modifications may be made to the invention without departing from the spirit and inventive concepts described herein. Therefore, it is not intended that the scope of the invention be limited to the specific embodiments illustrated and described.

What is claimed is:

1. A solid state lamp, using passive cooling, comprising:
a solid state light source;
an electrical connector for connection to an external source and for supplying power to the light source; and
a thermally conductive heat sink coupled to the light source, the lamp having a center axis, the heat sink comprising:
a thermally conductive support on which the light source is mounted; and
fins thermally coupled to the support, wherein the fins are arranged with respect to the support such that, when the lamp center axis is oriented vertically and the lamp is generating heat, the fins create an asymmetrical air flow that moves through or across a plane that is parallel to the center axis, the air flow being peripherally monoperiodic around a periphery of the lamp circumscribing the center axis.

2. The lamp of claim 1 wherein the fins are angled with respect to the center axis and asymmetrically arranged with respect to the center axis.

3. The lamp of claim 2 wherein an arrangement of angled fins on one side of the heat sink is substantially a mirror image of an arrangement of angled fins on an opposite side of the heat sink.

4. The lamp of claim 1 wherein an arrangement of the fins on one side of the heat sink is a mirror image of an arrangement of fins on an opposite side of the heat sink.

5. The lamp of claim 1 wherein the fins are arranged to create an asymmetrical heat pattern around the lamp when the lamp center axis is oriented vertically and the lamp is generating heat.

6. The lamp of claim 1 wherein ends of at least some of the fins are directly connected to a surface of the support.

7. The lamp of claim 1 wherein the electrical connector is part of a base of the lamp, wherein at least some of the fins extend completely between the support and the base.

8. The lamp of claim 7 further comprising a thermally conductive central shaft extending between the base and the support.

9. The lamp of claim 8 wherein the central shaft includes an opening for at least one wire leading to the light source, wherein the opening location is asymmetrical with respect to the center axis.

10. The lamp of claim 1 wherein the electrical connector is part of a base of the lamp, and wherein a wire conduit leading to the support is asymmetrical with respect to the center axis.

11. The lamp of claim 10 wherein the wire conduit extends between a cavity in a central shaft to the support, the cavity housing a driver, wherein the central shaft extends from the base.

12. The lamp of claim 11 wherein the central shaft does not extend to the support.

13. The lamp of claim 1 wherein the light source comprises light emitting diodes (LEDs) mounted overlying the support.

14. The lamp of claim 1 wherein an outer circumference of the lamp circumscribing the center axis is substantially circular and substantially symmetrical around the center axis.

15. The lamp of claim 1 wherein the lamp is a replacement for a standard A19 incandescent light bulb.

16. The lamp of claim 1 wherein the fins comprise first fins that are angled with respect to the center axis and asymmetrically arranged with respect to the center axis, the lamp further comprising:
one or more second fins extending from the support and intersecting a plurality of the first fins, the second fins conducting heat from the support to the plurality of the first fins.

17. The lamp of claim 16 further comprising a thermally conductive central shaft extending at least part way between the support and a base end of the lamp, the second fins also extending from the central shaft to conduct heat from the central shaft to the plurality of first fins.

18. The lamp of claim 1 wherein the light source is mounted on a first surface of the support, the support having a second surface opposite to the first surface, a periphery of the second surface being rounded to provide a reduction in air flow resistance as heated air flows from the heat sink and around a periphery of the lamp.

19. A method performed by a solid state lamp having a center axis that is oriented vertically, the lamp having a heat sink with fins for passively cooling a solid state light source, the method comprising:
generating heat by the solid state light source, the heat heating the heat sink and fins; and
creating an asymmetrical air flow, by an asymmetrical arrangement of the fins, the air flow moving through or across a plane that is parallel to the center axis, the air flow pattern being peripherally monoperiodic around a periphery of the lamp circumscribing the center axis.

20. The method of claim 19 wherein the fins are angled with respect to the center axis and asymmetrically arranged with respect to the center axis.

21. The method of claim 19 wherein the asymmetrical air flow creates an asymmetrical heat pattern around the lamp.

22. The method of claim 21 where the lamp has a base that includes an electrical connector for connection to a mains voltage, wherein the lamp is mounted in a ceiling can such that the base is above the light source, the ceiling can restricting a rising air flow, the asymmetrical air flow creating an asymmetrical heat pattern in the ceiling can that stirs air in the ceiling can for increased cooling of the heat sink.
